(19) United States
(12) Patent Application Publication
(10) Pub. No.: US 2022/0141811 A1
(43) Pub. Date: May 5, 2022

(54) INFORMATION PROCESSING DEVICE, INFORMATION PROCESSING METHOD, AND PROGRAM

(71) Applicant: SONY GROUP CORPORATION, TOKYO (JP)

(72) Inventor: RYOJI KADOTA, TOKYO (JP)

(21) Appl. No.: 17/433,703

(22) PCT Filed: Dec. 5, 2019
(86) PCT No.: PCT/JP2019/047579

§ 371 Date: Aug. 25, 2021

(30) Foreign Application Priority Data
Mar. 5, 2019 (JP) 2019-039184

(51) Int. Cl. H04W 72/04; H04W 4/38; G16Y 20/00

(52) U.S. Cl. CPC H04W 72/044; G16Y 20/00; H04W 4/38

(57) ABSTRACT

An information processing device includes: a communication unit that communicates with a plurality of IoT (Internet of Things) sensors; and a configuration unit that configures a management table that manages timings of access to the IoT sensors. Using a smallest value of sampling cycles of the plurality of IoT sensors as one cycle, the configuration unit configures the management table having a plurality of slots divided within the one cycle, and stores a frequency parameter indicating an access frequency to each of the IoT sensors in a different one of the slots.

### TECHNICAL FIELD

The present disclosure relates to an information processing device, an information processing method, and a program.

### BACKGROUND ART

Thus far, techniques have been proposed to obtain various types of information from a plurality of devices according to a collection schedule denoted in a table (see, for example, PTL 1 below).

### CITATION LIST

### Patent Literature

[PTL 1]

JP 2012-205278 A

### SUMMARY

### Technical Problem

In such a field, it is desirable to be able to obtain data from a plurality of devices efficiently.

Having been achieved in light of the foregoing, an object of the present disclosure is to provide an information processing device, an information processing method, and a program capable of efficiently obtaining data from a plurality of devices.

### Solution to Problem

The present disclosure is, for example, an information processing device including a communication unit that communicates with a plurality of IoT (Internet of Things) sensors, and a configuration unit that configures a management table that manages timings of access to the IoT sensors. Using a smallest value of sampling cycles of the plurality of IoT sensors as one cycle, the configuration unit configures the management table having a plurality of slots divided within the one cycle, and stores a frequency parameter indicating an access frequency to each of the IoT sensors in a different one of the slots.

Additionally, the present disclosure is, for example, an information processing method including: a configuration unit configuring a management table that manages timings of access to the IoT sensors; and using a smallest value of sampling cycles of the plurality of IoT sensors as one cycle, the configuration unit configuring the management table having a plurality of slots divided within the one cycle, and storing a frequency parameter indicating an access frequency to each of the IoT sensors in a different one of the slots.

Additionally, the present disclosure is, for example, a program that causes a computer to execute an information processing method including: a configuration unit configuring a management table that manages timings of access to the IoT sensors; and using a smallest value of sampling cycles of the plurality of IoT sensors as one cycle, the configuration unit configuring the management table having a plurality of slots divided within the one cycle, and storing a frequency parameter indicating an access frequency to each of the IoT sensors in a different one of the slots.

### BRIEF DESCRIPTION OF DRAWINGS

FIG. 1 is a block diagram illustrating an example of the configuration of an information processing system according to an embodiment.

FIG. 2 is a block diagram illustrating an example of the configuration of a sensor information obtainment device according to the embodiment.

FIG. 3A and FIG. 3B are diagrams referred to when describing a management table according to the embodiment.

FIG. 4 is a diagram illustrating details of the management table according to the embodiment.

FIG. 5 is a diagram referred to when describing an example of operations performed by the sensor information obtainment device according to the embodiment.

FIG. 6 is a flowchart illustrating an example of the flow of processing (an overall flow of processing) performed by the sensor information obtainment device according to the embodiment.

FIG. 7 is a flowchart illustrating an example of the flow of management table configuration processing according to the embodiment.

FIG. 8A and FIG. 8B are diagrams referred to when describing an example of processing performed when an IoT sensor capable of communicating with the sensor information obtainment device is added.

FIG. 9A and FIG. 9B are diagrams referred to when describing another example of processing performed when an IoT sensor capable of communicating with the sensor information obtainment device is added.

FIG. 10 is a flowchart illustrating an example of the flow of processing performed when an IoT sensor is added.

FIG. 11 is a flowchart illustrating an example of the flow of table configuration processing performed taking into account the fact that the number of IoT sensors with which the sensor information obtainment device can communicate can increase.

FIG. 12A and FIG. 12B are diagrams illustrating an example of an effect achieved by the embodiment.

FIG. 13A and FIG. 13B are diagrams illustrating an example of an effect achieved by the embodiment.

FIG. 14 is a diagram referred to when describing an example of an effect achieved by the embodiment.

FIG. 15 is a diagram referred to when describing an example of an effect achieved by the embodiment.

FIG. 16A and FIG. 16B are diagrams for describing a variation.

### DESCRIPTION OF EMBODIMENTS

Hereinafter, embodiments and the like of the present disclosure will be described with reference to the drawings. The description will be given in the following order.

### EMBODIMENT

<Variations>

The embodiment and the like described below are preferred specific examples of the present disclosure, and the content of the present disclosure is not limited to the embodiments.

### EMBODIMENT

[Configuration of Information Processing System]

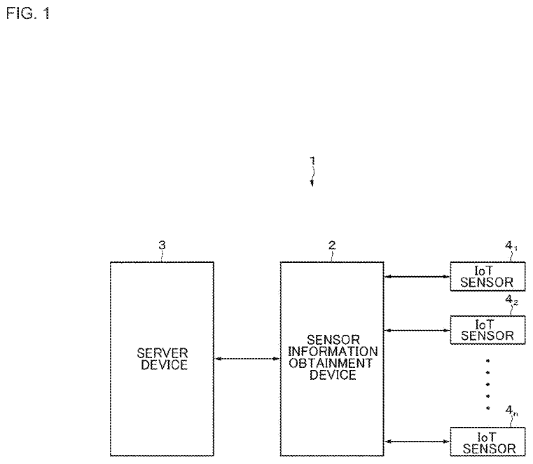

FIG. 1 is a diagram illustrating an example of the configuration of an information processing system (an information processing system 1) according to an embodiment. The information processing system 1 has a configuration including, for example, a sensor information obtainment device 2 serving as an example of an information processing device, a server device 3, and a plurality of IoT (Internet of Things) sensors (IoT sensor 4₁, IoT sensor 4₂, and so on up to IoT sensor 4ₙ). Note that in the following descriptions, the plurality of IoT sensors will be collectively referred to as “IoT sensor 4” as appropriate.

The sensor information obtainment device 2 obtains a sensor value from the IoT sensor 4 and sends the obtained sensor value to the server device 3. On the basis of the sensor value sent from the sensor information obtainment device 2, the server device 3 performs processing according to an application, e.g., processing for determining whether or not the IoT sensor 4 is malfunctioning, calculating a fee, or the like. The IoT sensor 4 is a sensor attached to or embedded in an electronic device such as a wearable device or a household appliance, or in another suitable object. The IoT sensor 4 has a sensing function for obtaining sensing data according to the type of the sensor, and a configuration for communicating with the sensor information obtainment device 2. An accelerometer, a gyrosensor, a temperature sensor, a humidity sensor, and the like can be given as specific examples of the IoT sensor 4. Note that the IoT sensor 4 may be a biometric sensor. Additionally, the aforementioned processing according to an application (e.g., processing for determining whether or not the IoT sensor 4 is malfunctioning, calculating a fee, or the like) may be performed by the sensor information obtainment device 2 rather than the server device 3.

The communication performed between the sensor information obtainment device 2 and the IoT sensors 4 may be wired or wireless. The communication performed between some of the IoT sensors 4 and the sensor information obtainment device 2 may be wired, and the communication between the other IoT sensors 4 and the sensor information obtainment device 2 may be wireless. General-purpose serial communication (e.g., I²C, SPI (Serial Peripheral Interface) communication) can be given as an example of wired communication. LAN (Local Area Network), Bluetooth (registered trademark), Wi-Fi (registered trademark), WUSB (Wireless USB), and the like can be given as examples of wireless communication. Additionally, LPWA (Low Power, Wide Area), which has recently been proposed as a communication standard suited to IoT sensors, may be applied as the wireless communication. As communication standards based on LPWA, for example, SIGFOX (sub-GHz band (866 MHz band, 915 MHz band, and 920 MHz band), with a maximum transmission speed of about 100 bps and a transmission distance of about several tens of kilometers), LoRa (sub-GHz band, with a maximum transmission speed of about 250 kbps and a transmission distance of about a maximum of 10 km), and the like can be given.

By performing such communication, the sensor information obtainment device 2 accesses the IoT sensor 4, and the sensor information obtainment device 2 makes a request for the sensing data to the IoT sensor 4. In response to the request from the sensor information obtainment device 2, the IoT sensor 4 sends the sensing data to the sensor information obtainment device 2.

[Example of Configuration of Sensor Information Obtainment Device]

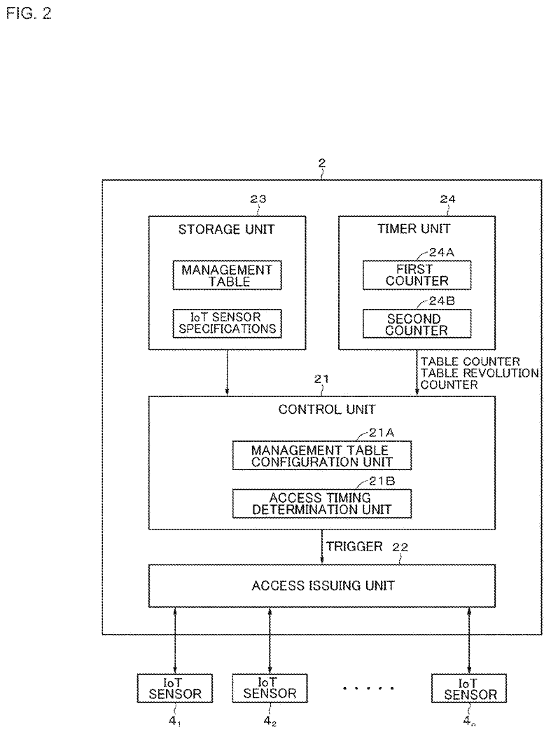

FIG. 2 is a block diagram illustrating an example of the configuration of the sensor information obtainment device 2 according to the embodiment. The sensor information obtainment device 2 includes, for example, a control unit 21, an access issuing unit 22 serving as an example of a communication unit, a storage unit 23, and a timer unit 24.

(Control Unit)

The control unit 21 comprehensively controls the various units of the sensor information obtainment device 2. As function blocks, the control unit 21 includes, for example, a management table configuration unit 21A and an access timing determination unit 21B serving as configuration units.

The management table configuration unit 21A configures, for example, a management table having a plurality of slots that are divided within one cycle, with the smallest value among sampling cycles of each of the plurality of IoT sensors 4 serving as one cycle. The management table configuration unit 21A finds a frequency parameter indicating an access frequency to each of the IoT sensors 4, and stores the frequency parameters which have been found in different slots. The management table stored in the management table configuration unit 21A is stored in the storage unit 23.

On the basis of the management table set by the management table configuration unit 21A, the access timing determination unit 21B determines whether or not to communicate with a predetermined IoT sensor 4. When it is determined that the current timing is a timing for communicating with the predetermined IoT sensor 4, the access timing determination unit 21B supplies a trigger, including information specifying the IoT sensor 4, to the access issuing unit 22.

(Access Issuing Unit 22)

The access issuing unit 22 is an element that communicates with the plurality of IoT sensors 4, and includes modulation and demodulation circuits and the like, according to the communication standard. On the basis of the trigger supplied from the access timing determination unit 21B, the access issuing unit 22 communicates with the IoT sensor 4 specified by the trigger, and makes a request for the sensing data to the IoT sensor 4. In response to the request, the sensing data is sent from the IoT sensor 4, and the sensing data is received by the access issuing unit 22. It is assumed that the access issuing unit 22 according to the present embodiment cannot access two or more IoT sensors 4 simultaneously. In other words, the access issuing unit 22 communicates with different IoT sensors 4 at different timings.

Note that the access issuing unit 22 can also be caused to function as a sending unit that sends the sensing data obtained from the IoT sensor 4 to the server device 3.

(Storage Unit)

The storage unit 23 is memory capable of storing various types of information, and a magnetic storage device such as an HDD (Hard Disk Drive), a semiconductor storage device, an optical storage device, and a magneto-optical storage device can be given as specific examples thereof. For example, programs executed by the control unit 21, the sensing data obtained from the IoT sensors 4, and the like are stored in the storage unit 23.

The management table configured by the management table configuration unit 21A is stored in the storage unit 23 according to the present embodiment. Specifications of the IoT sensors 4 with which the sensor information obtainment device 2 can communicate are stored in the storage unit 23 as well. These specifications are obtained by the sensor information obtainment device 2 and the IoT sensors 4 communicating with each other. The specifications of the IoT sensor 4 include the sampling cycle (ms) in which the IoT sensor 4 acquires sensing data and a physical quantity (Hz) which is the inverse thereof; a period of time required for the sensor information obtainment device 2 to obtain the sensing data from the IoT sensor 4 (called an “access period” hereinafter as appropriate); and the like.

Note that when an IoT sensor 4 with which the sensor information obtainment device 2 can communicate is newly added, the specifications of the added IoT sensor 4 are also obtained by the sensor information obtainment device 2 and stored in the storage unit 23. The addition of an IoT sensor 4 is determined by, for example, detecting the additional of a port to which the IoT sensor 4 connects. An IoT sensor 4 may be added by making an input to the sensor information obtainment device 2 to change the configuration.

(Timer Unit)

The timer unit 24 includes a first counter 24A and a second counter 24B. A first count value from the first counter 24A and a second count value from the second counter 24B are supplied to the control unit 21. In the following descriptions, the first count value and the second count value may be referred to as a table counter and a table revolution counter, respectively.

[Management Table]

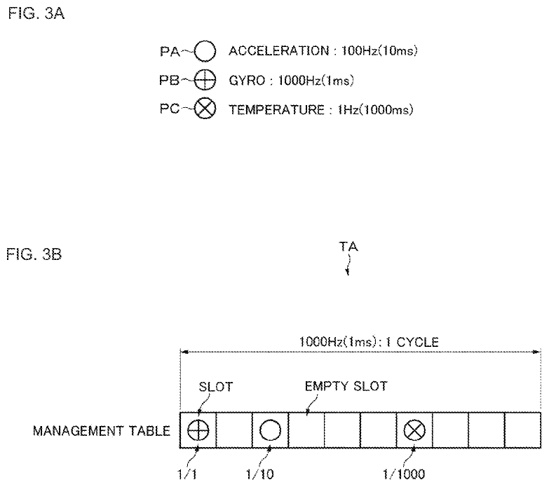

The management table according to the present embodiment will be described next. In the following descriptions, an accelerometer, a gyrosensor, and a temperature sensor will be described as the plurality of IoT sensors 4 with which the sensor information obtainment device 2 can communicate. As illustrated in FIG. 3A, the specifications of the accelerometer (physical quantity/sampling cycle) are (100 Hz/10 ms). The specifications of the gyrosensor (physical quantity/sampling cycle) are (1000 Hz/1 ms). The specifications of the temperature sensor (physical quantity/sampling cycle) are (1 Hz/1000 ms). These specifications are assumed to have already been obtained by the sensor information obtainment device 2.

A frequency parameter indicating an access frequency to the IoT sensor 4 is computed for each IoT sensor 4. For ease of understanding, in FIG. 3A and FIG. 3B, the frequency parameter of each IoT sensor 4 is schematically indicated by a predetermined mark. Specifically, a frequency parameter PA of the accelerometer is indicated by a circle, a frequency parameter PB of the gyrosensor is indicated by a circle containing a plus sign, and a frequency parameter PC of the temperature sensor is indicated by a circle containing an x.

FIG. 3B is a diagram illustrating an example of the management table configured by the management table configuration unit 21A (a management table TA). The management table configuration unit 21A configures the management table TA as follows, for example. A length L is defined for one cycle in the management table TA. For example, the smallest sampling cycle value among the IoT sensors 4 with which the sensor information obtainment device 2 can communicate is set as the length L of one cycle in the management table TA. Specifically, as illustrated in FIG. 3B, 1 ms, which is the sampling cycle of the gyrosensor, is set as the length L of one cycle in the management table TA.

Slots are set by dividing one cycle of the management table TA into any desired number. The number of slots indicates how many times the length L of one cycle is divided, i.e., a time resolution. A slot is a unit in which the frequency parameter of the IoT sensor 4 can be stored (denoted). Ten slots are set in the example illustrated in FIG. 3B. Note that a slot in which no frequency parameter is stored may be called an “empty slot” in the following descriptions.

For example, the management table configuration unit 21A finds the value of (one cycle of management table/sampling cycle of each IoT sensor), and sets the value which has been found as the frequency parameter. One cycle of the management table corresponds to the above-described length L of one cycle of the management table TA, and specifically, is 1 ms. According to the aforementioned equation, the frequency parameter PA of the accelerometer is 1/10, the frequency parameter PB of the gyrosensor is 1/1, and the frequency parameter PC of the temperature sensor is 1/1000.

The management table configuration unit 21A stores the frequency parameter which has been found in any of the empty slots. For example, as illustrated in FIG. 3B, the frequency parameter PB is stored in the first slot from the left in the management table TA (block 0), the frequency parameter PA is stored in the third slot from the left in the management table TA (block 2), and the frequency parameter PC is stored in the seventh slot from the left in the management table TA (block 6).

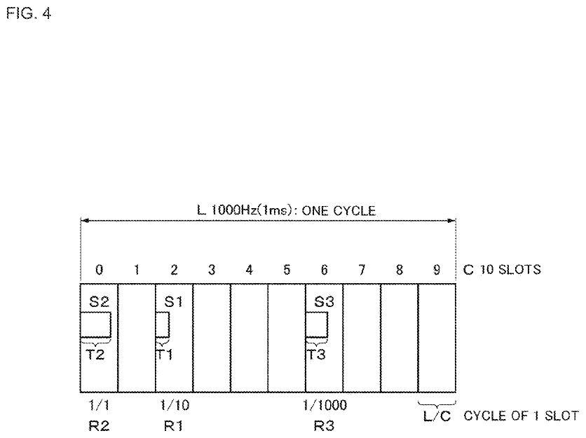

FIG. 4 is a diagram illustrating a specific example of the content of the management table TA. Assuming the number of slots is C, the slot number C in this example is 10 (ten slots). A minimum number of the slot number C is assumed to be the number of IoT sensors 4 with which the sensor information obtainment device 2 can communicate, for example. Additionally, assuming the time required to obtain data from each of the IoT sensors 4 is an access period Tk (where k=1, 2, and so on up to N), a relationship between L, C, and Tk is Tk<L/C. The slot number C, i.e., a cycle of one slot (L/C), is set as appropriate so that the stated relationship is satisfied. Note that in FIG. 4, the frequency parameter is represented by Rn, and the slot number in which the frequency parameter Rn is stored is represented by Sn (in the illustrated example, S1=2, S2=0, and S3=6).

As will be described later, the length L of one cycle, the slot number C, and the like can be changed dynamically by the number of IoT sensors 4 with which the sensor information obtainment device 2 can communicate increasing or decreasing.

[Example of Operations of Sensor Information Obtainment Device]

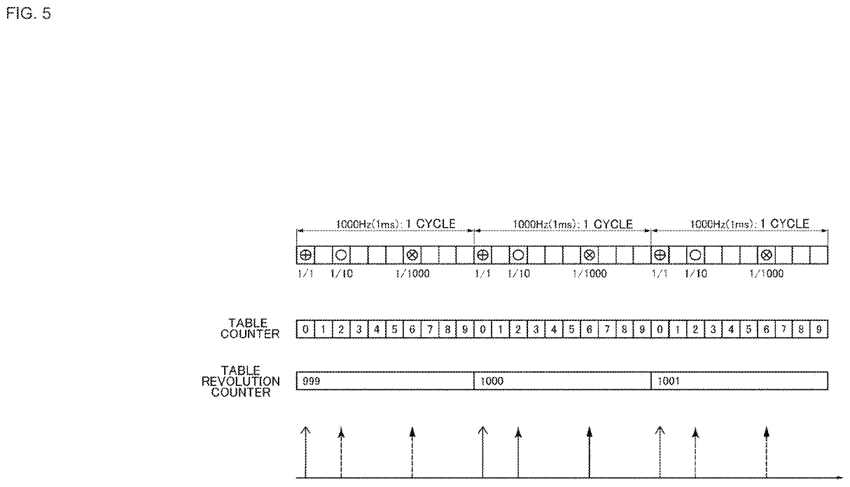

An example of operations of the sensor information obtainment device 2 will be described next with reference to FIG. 5. An example mainly of operations of the access timing determination unit 21B will be described first. On the basis of the management table TA, the access timing determination unit 21B determines whether or not to communicate with an IoT sensor 4. To be more specific, the access timing determination unit 21B determines whether a frequency parameter is stored in a predetermined slot of the management table TA on the basis of the table counter supplied from the first counter 24A, and when a frequency parameter is stored, determines whether or not to communicate with the IoT sensor corresponding to the frequency parameter on the basis of the frequency parameter and the table revolution counter supplied from the second counter 24B.

In the example illustrated in FIG. 5, time passes from the left to the right. The table counter corresponds to the slot number, and is incremented (+1) each time the slot subject to the determination changes. Additionally, the table revolution counter is incremented when the determination is complete for all the slots constituting one cycle of the management table TA. The table counter and the table revolution counter are reset at an appropriate timing (e.g., when power is turned on, when the number of IoT sensors 4 with which the sensor information obtainment device 2 can communicate increases or decreases, or the like). FIG. 5 illustrates progress partway through the count result of the table revolution counter, and “999”, “1000”, and “1001” are indicated as a specific example.

For ease of understanding, FIG. 5 illustrates the entire management table corresponding to the table revolution counter, but it is acceptable for the management table TA actually stored to be only one cycle's worth.

When the table revolution counter is incremented from “998” to “999”, the access timing determination unit 21B determines whether or not a frequency parameter is stored in the slot corresponding to the table counter “0”, and specifically, in the slot in block 0 of the management table TA. In this example, the frequency parameter PB of the gyrosensor is stored in the slot of block 0. The value of the frequency parameter PB is 1/1. This value indicates that it is necessary for the sensor information obtainment device 2 to access the gyrosensor every one cycle. Accordingly, the access timing determination unit 21B generates the trigger for accessing the gyrosensor and supplies the trigger to the access issuing unit 22. The trigger being supplied to the access issuing unit 22 is schematically illustrated in FIG. 5 by a solid line arrow pointing upward. The access issuing unit 22 communicates with the gyrosensor in accordance with the supplied trigger, and obtains the sensing data measured by the gyrosensor.

Then, when the table counter is incremented, the access timing determination unit 21B determines whether or not a frequency parameter is stored in the next slot (the slot in block 1). No frequency parameter is stored in the slot in block 1, and thus the slot subject to the determination transitions to the next slot (the slot in block 2) in accordance with the table counter being incremented.

The frequency parameter PA of the accelerometer is stored in the slot in block 2. The value of the frequency parameter PA is 1/10. This value indicates that it is necessary for the sensor information obtainment device 2 to access the accelerometer every ten cycles. Whether or not this is ten cycles can be determined according to whether or not the table revolution counter is a multiple of 10. In this example, because the table revolution counter is “999”, the sensor information obtainment device 2 does not need to access the accelerometer, and thus the access timing determination unit 21B does not output the trigger. The access timing determination unit 21B not outputting a trigger is schematically illustrated in FIG. 5 by a dotted line arrow pointing upward.

The processing is repeated in the same manner. When the slot subject to the determination is the slot in block 6, the frequency parameter PC of the temperature sensor is stored in that slot. The value of the frequency parameter PC is 1/1000. This value indicates that it is necessary for the sensor information obtainment device 2 to access the temperature sensor every 1000 cycles. Whether or not this is 1000 cycles can be determined according to whether or not the table revolution counter is a multiple of 1000. In this example, because the table revolution counter is “999”, the sensor information obtainment device 2 does not need to access the temperature sensor, and thus the access timing determination unit 21B does not output the trigger. The access timing determination unit 21B not outputting a trigger is schematically illustrated in FIG. 5 by a dotted line arrow pointing upward.

Once the table counter is incremented to a maximum value (“9” in this example), the table counter is reset and the table revolution counter is incremented. When the table revolution counter is “1000”, the sensor information obtainment device 2 makes a request to obtain the sensing data to all of the gyrosensor, the accelerometer, and the temperature sensor. The same processing is repeated thereafter.

[Flow of Processing]

(Overall Flow of Processing)

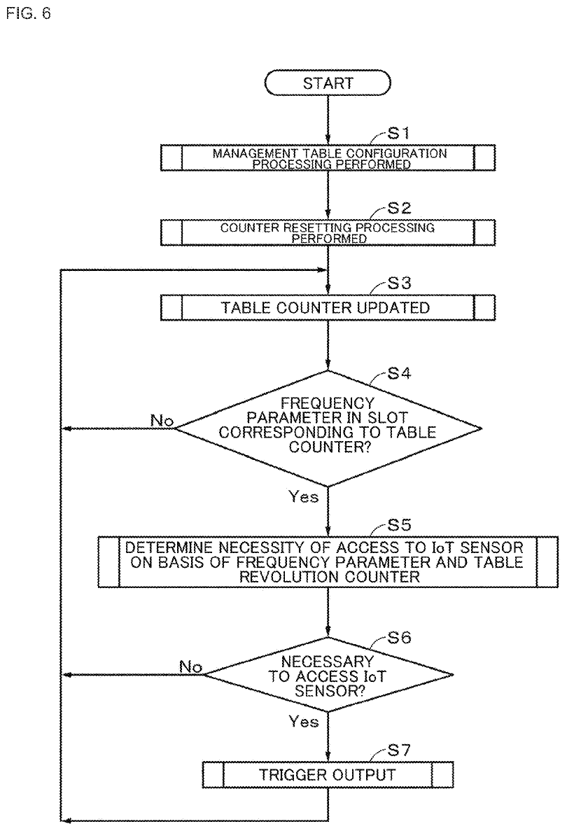

FIG. 6 is a flowchart illustrating an example of the flow of processing (an overall flow of processing) performed by the sensor information obtainment device 2. In step S1, management table configuration processing is performed. In other words, the management table TA is configured by the management table configuration unit 21A. The processing then moves to step S2.

In step S2, counter resetting processing is performed by the timer unit 24. Specifically, the table counter counted by the first counter 24A is reset. Additionally, the table revolution counter counted by the second counter 24B is reset. This resetting is performed under the control of the control unit 21, for example. The processing then moves to step S3.

In step S3, the table counter is updated (incremented) by the first counter 24A. Note that for the first time, “0” is counted for the table counter. Additionally, when the table counter is at a maximum value (e.g., “9”), the table counter is updated to “0” and the table revolution counter is incremented. The table counter and the table revolution counter are supplied to the control unit 21. The processing then moves to step S4.

In step S4, the access timing determination unit 21B determines whether or not there is a frequency parameter in the slot of the management table TA corresponding to the table counter. If there is no frequency parameter, the processing returns to step S3. If there is a frequency parameter, the processing moves to step S5.

In step S5, referring to the table revolution counter, the access timing determination unit 21B determines, on the basis of the frequency parameter and the table revolution counter, whether or not it is necessary to access the IoT sensor 4. A specific example of the determination as to whether or not access is necessary is as described above. The processing then moves to step S6.

In step S6, it is determined whether or not it is necessary to access the IoT sensor 4 as a result of the determination process of step S5. If it is not necessary to access the IoT sensor 4, the processing returns to step S3. If it is necessary to access the IoT sensor 4, the processing moves to step S7.

In step S7, it is necessary to access the IoT sensor 4, and thus a trigger is output from the access timing determination unit 21B to the access issuing unit 22. The processing then moves to step S3.

The access issuing unit 22 which has been supplied with the trigger communicates, for example, with the IoT sensor 4 designated in the trigger in order to make a request for the sensing data to that IoT sensor 4. The sensing data sent from the IoT sensor 4 is then received by the access issuing unit 22, and the received sensing data is stored in the storage unit 23, sent to the server device 3, or the like.

(Flow of Management Table Configuration Processing)

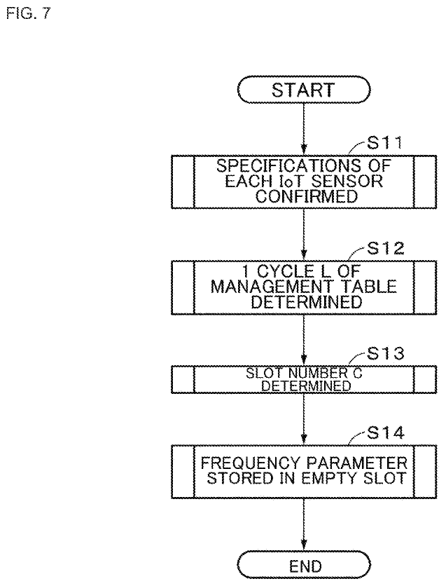

FIG. 7 is a flowchart illustrating an example of the flow of management table configuration processing. The management table configuration processing is performed by the management table configuration unit 21A, for example. The processing described hereinafter is performed as processing involved in an initial configuration, such as processing performed the first time the sensor information obtainment device 2 is used, calibration processing performed when power is turned on, or the like, for example.

In step S11, the specifications of the IoT sensors 4 with which the sensor information obtainment device 2 can communicate are confirmed by referring to the information stored in the storage unit 23. The processing then moves to step S12.

In step S12, the length L of one cycle of the management table TA is determined. For example, the smallest sampling cycle among the sampling cycles of the plurality of IoT sensors 4 is determined as the length L of one cycle. The processing then moves to step S13.

In step S13, the slot number C of the management table TA is determined. The slot number C is set as appropriate on the basis of the number of IoT sensors 4 with which the sensor information obtainment device 2 can communicate, the access period for the IoT sensors 4, and the like. The processing then moves to step S14.

In step S14, the frequency parameter is found for each IoT sensor 4 with which the sensor information obtainment device 2 can communicate, and the frequency parameter which has been found is stored in the appropriate empty slot. The processing then ends.

[Processing when IoT Sensor is Added]

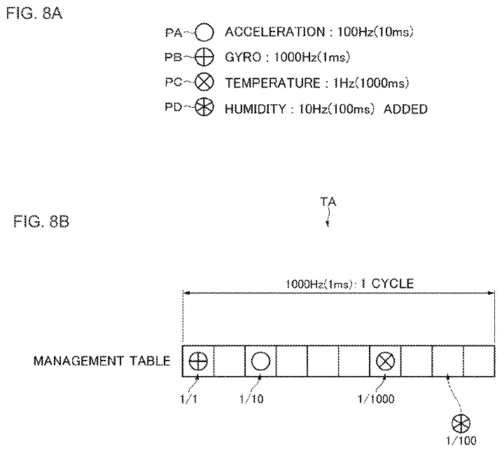

Note that an IoT sensor 4 with which the sensor information obtainment device 2 can communicate can be newly added. For example, consider an example in which a humidity sensor (a sensor having specifications of 10 Hz/100 ms and a frequency parameter of 1/100) is newly added as an IoT sensor 4 with which the sensor information obtainment device 2 can communicate, as illustrated in FIG. 8A. When the number of IoT sensors 4 with which the sensor information obtainment device 2 can communicate increases, the management table configuration unit 21A determines whether or not to reconfigure the management table. In the present embodiment, the management table being reconfigured includes at least storing the frequency parameter of the newly-added IoT sensor 4 in the management table. To be more specific, in the present embodiment, the management table being reconfigured is a generic way of referring to re-creating the management table by adding or deleting frequency parameters stored in the management table, changing the number of slots in the management table, reconfiguring L of one cycle and the slot number C, re-computing the frequency parameters, and the like.

In the foregoing example, of the four IoT sensors 4, the smallest sampling cycle is 1 ms. It is therefore not necessary to change the length L of one cycle in the management table TA. In this case, the management table is reconfigured by storing a frequency parameter PD of the humidity sensor of the management table TA in the appropriate empty slot of the management table TA, as schematically illustrated in FIG. 8B. If there is no empty slot, the management table may be reconfigured by increasing the slot number C.

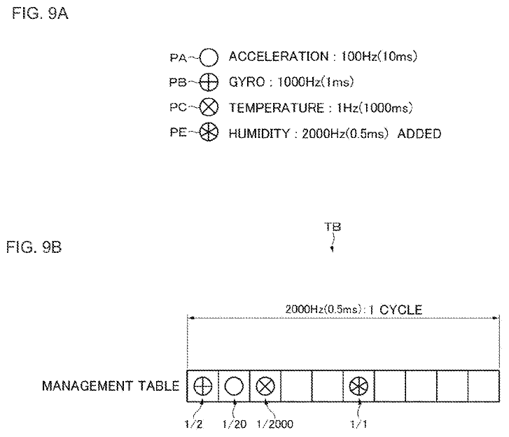

As another example, consider, as illustrated in FIG. 9A, an example in which, as an IoT sensor 4 with which the sensor information obtainment device 2 can communicate, a humidity sensor (a sensor having specifications of 2000 Hz/0.5 ms) is newly added. Of the four IoT sensors 4, the smallest sampling cycle is 0.5 ms. It is therefore necessary to change the length L of one cycle in the management table TA. Specifically, as illustrated in FIG. 9B, the management table TA is reconfigured to a management table TB, in which the length L of one cycle is 0.5 ms.

The frequency parameters of the IoT sensors 4 are updated in response to the length L of one cycle being updated. Specifically, the frequency parameter PA of the accelerometer is updated to 1/20 (0.5/10). Additionally, the frequency parameter PB of the gyrosensor is updated to ½ (0.5/1). Additionally, the frequency parameter PC of the temperature sensor is updated to 1/2000 (0.5/1000). Note that a frequency parameter PE of the humidity sensor is 1/1 (0.5/0.5).

The frequency parameters of the IoT sensors 4 which have been found are then stored in the appropriate empty slots in the management table TB.

(Flow of Processing Performed when IoT Sensor is Added)

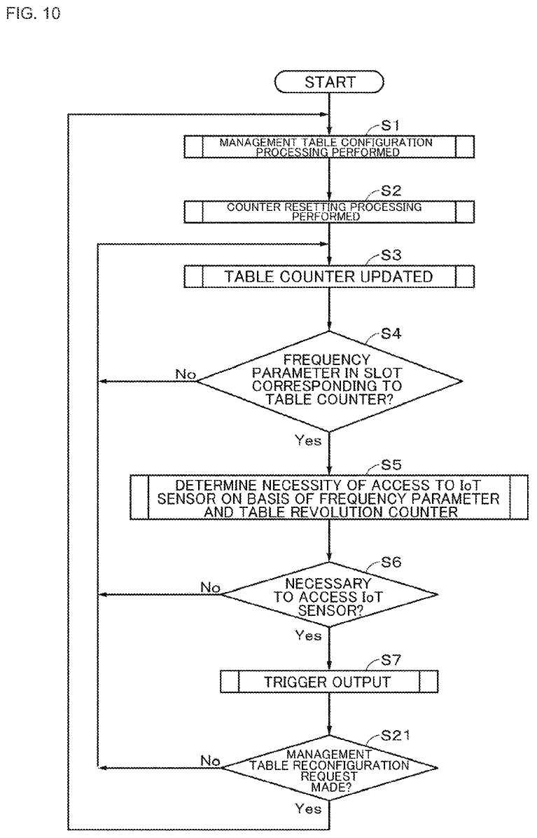

FIG. 10 is a flowchart illustrating an example of the flow of processing performed when an IoT sensor 4 is added. The details of the processes of steps S1 to S7 have already been described, and thus redundant descriptions will not be given. The processing moves to step S21 after the process of step S7.

In step S21, it is determined whether or not a reconfiguration request has been made for reconfiguring the management table in response to an increase in the number of IoT sensors 4 with which the sensor information obtainment device 2 can communicate. This reconfiguration request is executed as an interrupt process performed in response to the number of IoT sensors 4 with which the sensor information obtainment device 2 can communicate increasing, for example. If there is no reconfiguration request to reconfigure the management table, the processing returns to step S3. If there is a reconfiguration request to reconfigure the management table, the processing returns to step S1.

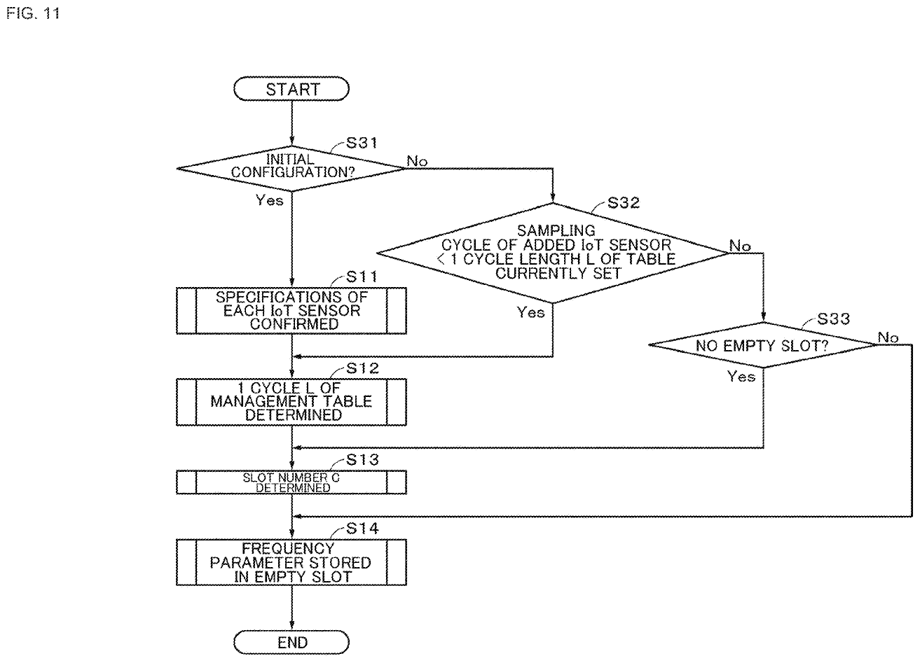

FIG. 11 is a flowchart illustrating an example of the flow of table configuration processing performed taking into account the fact that the number of IoT sensors 4 with which the sensor information obtainment device 2 can communicate can increase. In step S31, the management table configuration unit 21A determines whether or not the management table is in an initial configuration. If the result of the determination processing indicates that the management table is in the initial configuration, the processing moves to step S11. The details of the processes of steps S11 to S14 have already been described, and thus redundant descriptions will not be given.

If the result of the determination processing in step S31 indicates that the management table is not in the initial configuration, the processing moves to step S32. The management table not being in the initial configuration is a situation where the number of IoT sensors 4 has increased while the sensor information obtainment device 2 is operating, for example. The processing for reconfiguring the management table is executed thereafter.

In step S32, it is determined whether or not the sampling cycle of the newly-added IoT sensor 4 is smaller than one cycle of the currently-configured management table, i.e., the smallest sampling cycle among the sampling cycles of the IoT sensors 4 aside from the IoT sensor 4 which has been added. If the sampling cycle of the newly-added IoT sensor 4 is smaller than one cycle of the currently-configured management table, the processing moves to step S12. Then, after the management table is reconfigured with the sampling cycle of the newly-added IoT sensor 4 used as the length L of one cycle through the process of step S12, the frequency parameters are re-computed. The management table is then re-configured through the above-described processing of step S12 to step S14.

If it is determined in the determination processing of step S32 that the sampling cycle of the newly-added IoT sensor 4 is larger than one cycle of the currently-configured management table, the processing moves to step S33. In step S33, it is determined whether or not there is an empty slot. If there is no empty slot, the processing moves to step S13. Then, in step S13, the management table is reconfigured by performing processing for increasing the slot number C, for example, and an empty slot is generated. The frequency parameter of the added IoT sensor 4 is stored in the empty slot.

If the determination processing of step S33 indicates that there is an empty slot, the processing moves to step S14. In step S14, the management table is reconfigured by storing the frequency parameter of the newly-added IoT sensor 4 in the appropriate empty slot.

Although the foregoing example describes a case where an IoT sensor 4 which can communicate with the sensor information obtainment device 2 is newly added, the configuration is not limited thereto. For example, the same processing may be performed when the IoT sensors 4 which can communicate with the sensor information obtainment device 2 have decreased due to an IoT sensor 4 malfunctioning or being unable to communicate.

[Effects Achieved by Embodiment]

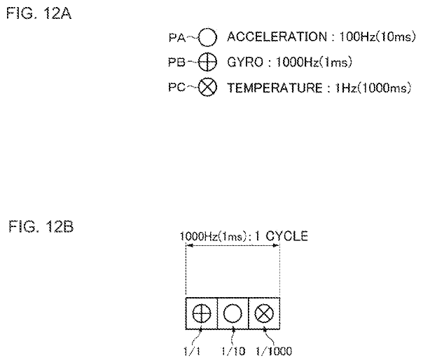

For example, the following effects can be achieved by the present embodiment. For example, when the number of IoT sensors 4 which can communicate with the sensor information obtainment device 2 is 3 as illustrated in FIG. 12A, a management table having the same number of slots as there are IoT sensors 4 as a minimum value may be prepared, and the frequency parameters may be stored in those slots, as illustrated in FIG. 12B. Accordingly, it is not necessary to prepare a large-scale management table having many slots, which makes it possible to save space in memory.

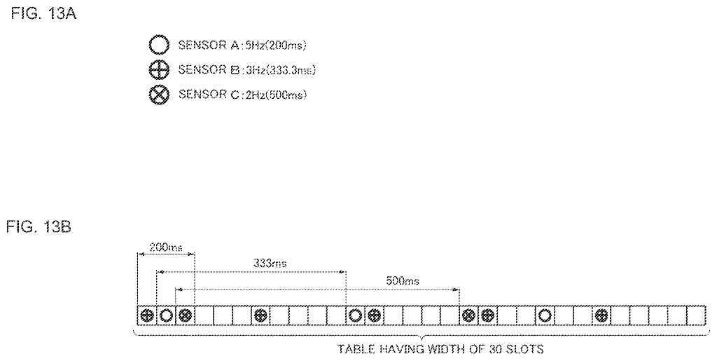

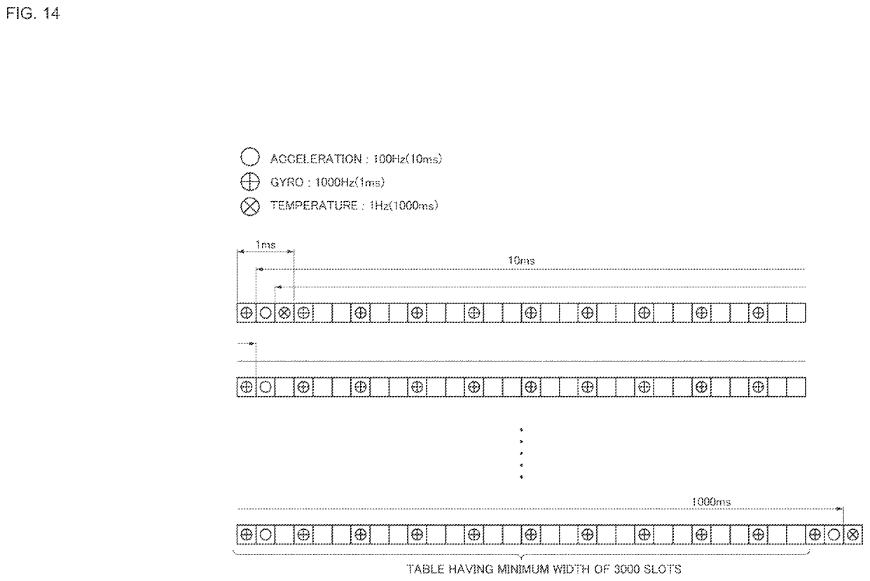

Additionally, for example, consider the three IoT sensors having the specifications indicated in FIG. 13A (IoT sensors A, B, and C). In this case, it is conceivable to configure the management table using the least common multiple of the obtainment cycles of the three IoT sensors. However, if the least common multiple is used, it is necessary to prepare a management table having 30 slots, for example, as illustrated in FIG. 13B, which increases the size of the management table. Likewise, in the case of three IoT sensors illustrated in FIG. 14, a management table having a minimum of 3000 slots will be necessary as indicated in the drawing, which increases the size of the management table. However, according to the present embodiment, a situation where the size of the management table increases as described above can be suppressed, which makes it possible to save space in memory.

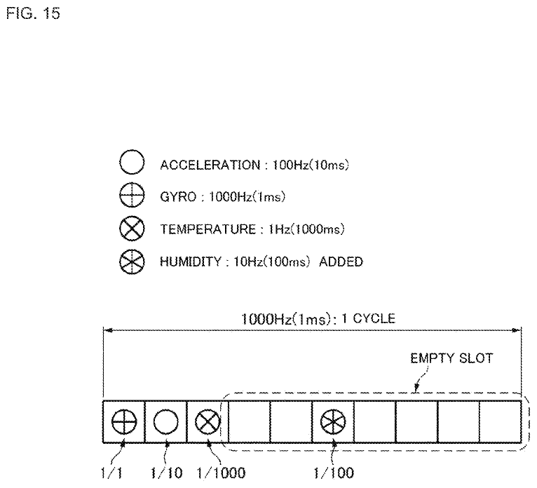

Additionally, as schematically illustrated in FIG. 15, the management table according to the embodiment makes it clear where the empty slots are. As such, even if an IoT sensor 4 which can communicate with the sensor information obtainment device 2 is newly added, an empty slot in which the frequency parameter of that IoT sensor 4 is to be stored can be found with ease. Accordingly, an IoT sensor 4 which can communicate with the sensor information obtainment device 2 can be added easily. Additionally, the size of the management table can be reduced as described above, and the number of slots can be reduced as well, which makes it possible to reduce the computational cost of searching for empty slots.

### VARIATIONS

Although an embodiment of the present disclosure has been described in detail thus far, the content of the present disclosure is not limited to the above-described embodiment, and many variations can be made based on the technical spirit of the present disclosure. Variations will be described hereinafter.

The configuration of the information processing system according to the embodiment can be changed as appropriate. For example, the sensor information obtainment device and the server device may be the same device.

The configuration of the sensor information obtainment device according to the embodiment can be changed as appropriate. For example, the sensor information obtainment device may include a plurality of management tables, as well as a plurality of access timing determination units and access issuing units. According to this configuration, the sensor information obtainment device can access a plurality of different IoT sensors simultaneously. For example, the plurality of access issuing units can access the IoT sensors independently.

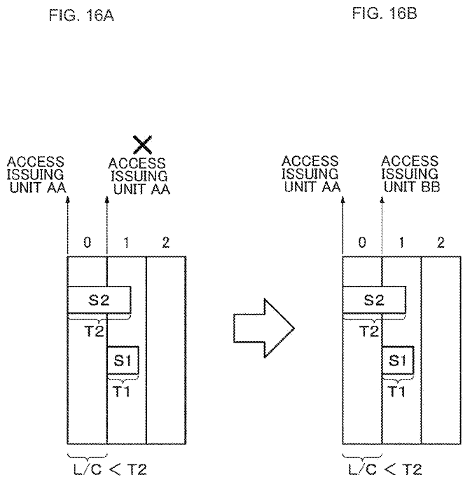

Additionally, the sensor information obtainment device may include a plurality of only the access issuing units. For example, assume that there is one access issuing unit (an access issuing unit AA), and in a state where Tk<L/C is not satisfied, the timings of access to an IoT sensor 4a and an IoT sensor 4b are stored in sequential slots. In this case, as illustrated in FIG. 16A, the access issuing unit AA will access the IoT sensor 4a across the next slot as well, and will therefore not be able to correctly access the IoT sensor 4b denoted in the next slot. However, providing two access issuing units makes it possible for an access issuing unit BB to access the IoT sensor 4b at the timing of the next slot, as illustrated in FIG. 16B.

The present disclosure can also be realized by a device, a method, a program, a system, and the like. For example, a program that executes the functions described in the above-described embodiment is made downloadable, and a device that does not have the functions described in the embodiment can perform control described in the embodiment in the device by downloading and installing the program. The present disclosure can also be realized by a server that distributes such a program. In addition, the items described in the embodiment and variations can be combined as appropriate.

Furthermore, the content of the present disclosure is not to be interpreted as being limited by the effects described as examples here.

The present disclosure can also adopt the following configurations.

(1)

An information processing device including a communication unit that communicates with a plurality of IoT (Internet of Things) sensors, and a configuration unit that configures a management table that manages timings of access to the IoT sensors.

Using a smallest value of sampling cycles of the plurality of IoT sensors as one cycle, the configuration unit configures the management table having a plurality of slots divided within the one cycle, and stores a frequency parameter indicating an access frequency to each of the IoT sensors in a different one of the slots.

(2)

The information processing device according to (1), wherein the configuration unit reconfigures the management table when the number of the IoT sensors capable of communication increases or decreases.

(3)

The information processing device according to (2), wherein when the sampling cycle of an IoT sensor that has been newly added is smaller than one cycle of the management table, the configuration unit reconfigures the sampling cycle of the IoT sensor that has been newly added as one cycle of the management table.

(4)

The information processing device according to (3),

wherein the configuration unit updates the frequency parameter of each of the IoT sensors in accordance with the one cycle of the management table being reconfigured.

(5)

The information processing device according to (2),

wherein when the sampling cycle of the IoT sensor that has been newly added is larger than one cycle of the management table and there is no empty slot in which the frequency parameter of the IoT sensor that has been newly added is to be stored, the configuration unit increases the number of slots in the management table.

(6)

The information processing device according to (5), wherein when there is an empty slot, the configuration unit stores, in the empty slot, the frequency parameter of the IoT sensor that has been newly added.

(7)

The information processing device according to any one of (1) to (6), wherein the configuration unit sets a value of (one cycle of management table/sampling cycle of each IoT sensor) as the frequency parameter.

(8)

The information processing device according to any one of (1) to (7), wherein the configuration unit configures the management table when power is turned on.

(9)

The information processing device according to any one of (1) to (8), further including:

an access timing determination unit that determines whether or not to communicate with the IoT sensors, on the basis of the management table.

(10)

The information processing device according to (9),

wherein the access timing determination unit determines whether the frequency parameter is stored in a predetermined slot of the management table on the basis of a first count value supplied from a first counter, and when the frequency parameter is stored, determines whether or not to communicate with an IoT sensor corresponding to the frequency parameter on the basis of the frequency parameter and a second count value supplied from a second counter.

(11)

The information processing device according to any one of (1) to (10), wherein the communication unit communicates with different IoT sensors at different timings.

(12)

The information processing device according to any one of (1) to (11), wherein the communication unit sends sensing data obtained from the IoT sensors to another device.

(13)

An information processing method including:

a configuration unit configuring a management table that manages timings of access to the IoT sensors;
and using a smallest value of sampling cycles of the plurality of IoT sensors as one cycle, the configuration unit configuring the management table having a plurality of slots divided within the one cycle, and storing a frequency parameter indicating an access frequency to each of the IoT sensors in a different one of the slots.

(14)

A program that causes a computer to execute an information processing method including:

a configuration unit configuring a management table that manages timings of access to the IoT sensors;
and using a smallest value of sampling cycles of the plurality of IoT sensors as one cycle, the configuration unit configuring the management table having a plurality of slots divided within the one cycle, and storing a frequency parameter indicating an access frequency to each of the IoT sensors in a different one of the slots.

### REFERENCE SIGNS LIST

1 Information processing system
2 Sensor information obtainment device
3 Server device
4 IoT sensor
21 Control unit
21A Management table configuration unit
21B Access timing determination unit
22 Access issuing unit
23 Storage unit
24 Timer unit
24A First counter
24B Second counter

1. An information processing device comprising:
a communication unit that communicates with a plurality of IoT (Internet of Things) sensors; and
a configuration unit that configures a management table that manages timings of access to the IoT sensors,
wherein using a smallest value of sampling cycles of the plurality of IoT sensors as one cycle, the configuration unit configures the management table having a plurality of slots divided within the one cycle, and stores a frequency parameter indicating an access frequency to each of the IoT sensors in a different one of the slots.

2. The information processing device according to claim 1,
wherein the configuration unit reconfigures the management table when the number of the IoT sensors capable of communication increases or decreases.

3. The information processing device according to claim 2,
wherein when the sampling cycle of an IoT sensor that has been newly added is smaller than one cycle of the management table, the configuration unit reconfigures the sampling cycle of the IoT sensor that has been newly added as one cycle of the management table.

4. The information processing device according to claim 3,
wherein the configuration unit updates the frequency parameter of each of the IoT sensors in accordance with the one cycle of the management table being reconfigured.

5. The information processing device according to claim 2,
wherein when the sampling cycle of the IoT sensor that has been newly added is larger than one cycle of the management table and there is no empty slot in which the frequency parameter of the IoT sensor that has been newly added is to be stored, the configuration unit increases the number of slots in the management table.

6. The information processing device according to claim 5,
wherein when there is an empty slot, the configuration unit stores, in the empty slot, the frequency parameter of the IoT sensor that has been newly added.

7. The information processing device according to claim 1,
wherein the configuration unit sets a value of (one cycle of management table/sampling cycle of each IoT sensor) as the frequency parameter.

8. The information processing device according to claim 1,
wherein the configuration unit configures the management table when power is turned on.

9. The information processing device according to claim 1, further comprising:
an access timing determination unit that determines whether or not to communicate with the IoT sensors, on the basis of the management table.

10. The information processing device according to claim 9,
wherein the access timing determination unit determines whether the frequency parameter is stored in a predetermined slot of the management table on the basis of a first count value supplied from a first counter, and when the frequency parameter is stored, determines whether or not to communicate with an IoT sensor corresponding to the frequency parameter on the basis of the frequency parameter and a second count value supplied from a second counter.

11. The information processing device according to claim 1,
wherein the communication unit communicates with different IoT sensors at different timings.

12. The information processing device according to claim 1,
wherein the communication unit sends sensing data obtained from the IoT sensors to another device.

13. An information processing method comprising:
a configuration unit configuring a management table that manages timings of access to the IoT sensors; and
using a smallest value of sampling cycles of the plurality of IoT sensors as one cycle, the configuration unit configuring the management table having a plurality of slots divided within the one cycle, and storing a frequency parameter indicating an access frequency to each of the IoT sensors in a different one of the slots.

14. A program that causes a computer to execute an information processing method, the method comprising:
a configuration unit configuring a management table that manages timings of access to the IoT sensors; and
using a smallest value of sampling cycles of the plurality of IoT sensors as one cycle, the configuration unit configuring the management table having a plurality of slots divided within the one cycle, and storing a frequency parameter indicating an access frequency to each of the IoT sensors in a different one of the slots.
